(19) United States
(12) Patent Application Publication
(10) Pub. No.: US 2011/0317512 A1
(43) Pub. Date: Dec. 29, 2011

(54) METHOD AND APPARATUS FOR PREPARING AND DISPENSING DENTAL ALGINATE COMPOUND

(76) Inventors: Bradford D. Overton, Broken Arrow, OK (US); James K. Hays, Broken Arrow, OK (US)

(21) Appl. No.: 12/823,152

(22) Filed: Jun. 25, 2010

(51) Int. Cl. B01F 15/02

(52) U.S. Cl. 366/151.1; 366/169.1

(57) ABSTRACT

A method and apparatus for preparing and dispensing dental alginate compound comprising a disposable alginate mixing container containing a pre-measured amount of alginate compound powder, a water storage and dispensing means, and an alginate dispensing means. The alginate mixing container is comprised of an agitator utilizing mixing cords that are oriented at an angle to the plane of the arms of the agitator receiving the cords, and a plunger that is slidably engaged with the walls of the cylindrical mixing container. The angular relationship of the cords to the agitator arm pre-stresses the cords against the reactive forces generated by the impingement of the mixing cords and the alginate compound during mixing, and also provides a means to initiate the folding of the cords during the linear movement of the plunger as the alginate compound is dispensed from the mixing container into an impression tray.

The water dispensing means is comprised of a constant volume pump driven by a motor under controls for speed and position.

### BACKGROUND OF THE INVENTION

1. Field of the Invention

The disclosed invention is directed generally towards the fields of dentistry and orthodontics, and more specifically to the field of the methods and systems for the preparation and dispensing of alginate compound for making dental impressions.

2. Description of Related Art

During the practice of Dentistry or Orthodontics, it becomes necessary from time to time to take an impression of the patient's teeth in order to provide treatment or to complete a required procedure. To perform this procedure presently, an alginate compound is prepared by mixing alginate powder with a precise quantity of water in an open container or bowl using a paddle or spatula. The alginate compound is mixed until smooth and even in consistency, after which it is put into a dental impression tray and placed in the patient's mouth. After a short period of time, the alginate compound sets and becomes firm. Upon removal from the patient's mouth, an impression of the patient's dental arrangement is left in the alginate compound in the tray. The alginate eventually hardens and is then used as a mold to cast a mock-up of the patient's teeth and dental arrangement. From this model, the dentist or orthodontist may plan treatment procedures, or make dental appliances suitable for the specific patient's dental arrangement.

There are a number of problems with this common method of alginate preparation. The first problem is that the alginate compound is a fine powder before being mixed with water. This powder becomes air-borne during the preparation process, and can be irritating if inhaled. Additionally, it can get into instruments and equipment in the dental office, some of which are quite expensive and intolerant to this type of contamination.

An additional problem is the sterility and cleanliness of the equipment used to mix the alginate compound. Every item going into the patient's mouth during dental and orthodontic procedures is sterilized by use of an autoclave, a type of oven. The means of sterilization is the application of heat, which kills any harmful micro-organisms that may reside on the instruments or appliances being sterilized. The paddles, bowls and other equipment used to prepare the alginate compound are not processed through the autoclave due to the materials of construction of these components and the heat of the autoclave procedure.

Another problem is the consistency and uniformity required of the alginate compound mixture. The ratio of water to alginate powder is required to be precise, and this precision is dependent on the complete incorporation of the water into the powder. If some of the alginate powder is un-wetted and unmixed due to being in inaccessible places in the mixing vessel, the ration of water to powder is effectively too high, and the alginate compound will not perform properly. The compound is also sensitive to the formation and entrapment of bubbles; the product is intended to be mixed smooth with a minimum of entrapped air or bubbles.

It is therefore desirable to provide a method and apparatus to prepare alginate compound which incorporates a means to dispense accurate amounts of sterile water to a disposable pre-sterilized mixing container pre-filled with alginate compound powder, which itself comprises a mixing and dispensing means that minimizes the incorporation of air and the formation of bubbles, minimizes the tendency of the mixing means to produce cavitation in the compound during mixing thereby creating the same problem, maximize the coverage or reach of the mixing element in the container to assure the incorporation of alginate powder into the mixed compound from the corners of the mixing container, and provides a plunger externally motivated by an apparatus, which forces the alginate from the container through an incorporated nozzle into an impression tray.

The present art does not address some of the problems that are solved by the disclosed invention. Devices and methods instructed by the existing art do not address the challenges of mixing alginate to uniform consistency by providing a means of mixing that can agitate alginate powder in the upper and lower corners of the mixing container, and do so while minimizing cavitation or entraining air or bubbles in the alginate mix by the shape and length of the mixing means. The disclosed apparatus of this invention solves this problem by the use of flexible cords for the agitation elements, which randomly traverse through the compound being mixed in order to provide an improved mixing function and a more consistent and through mixing of alginate powders and water used to make the alginate compound.

U.S. Pat. No. 7,018,089 discloses a mixing disk incorporated by a syringe to mix and dispense compounds. However, this fixed disk arrangement is not suitable for mixing alginate compounds in that the agitation that is able to be produced by such a fixed disk is inadequate for the application of mixing alginate compounds.

None of the art instructs nor anticipates cords as desirable means to perform the agitation of the compounds being mixed, in order to minimize the entrainment of air and cavitation of the mixing element in the compound during mixing.

U.S. Pat. No. 7,278,778 discloses a dispensing device utilizing a mixing paddle to accomplish agitation. However, this mixing paddle does not provide adequate agitation in the corners of the dispensing device to fully mix alginate powder with water. Additionally, this type of mixing paddle creates cavitation in the compound at high mixing speeds, due to its rigidity, and the size and arrangement of holes in the mixing paddles, and this cavitation causes bubbles to form in the alginate compound, which is undesirable because it compromises the structure of any dental impressions taken with the compound in an impression tray, and the bubbles create inaccuracies in any castings made from the dental impression of an alginate compound mix that has entrained bubbles.

None of the existing art instructs the need of an oblique angular relationship between the cords and the plane of the agitator arms comprising the mixing element of the present invention, which facilitates the ability to provide mixing action by pre-stressing the mixing cords against the reactive forces of impingement of the mixing cords against the alginate compound being mixed, while allowing the cords to collapse and fold flat during the dispensing of the alginate by the slidable movement of the plunger-mixer assembly along the center axis of the mixing container, and preventing the cords from becoming a structural column within the device that would prevent the plunger from being fully depressed to dispense the alginate compound mix inside the container.

The invention disclosed herein is able to address the issues of the prior art, and is simple enough to be cost-effective when used in a clinical setting. The present invention addresses these problems through a series of improvements and innovations to the mixing and dispensing process.

### SUMMARY OF THE INVENTION

In general, the invention relates to a method and apparatus to prepare and dispense alginate compound into an impression tray for the purpose of making dental impressions comprising: a container that holds sterile water, a means of accurately dispensing a quantity of said water from the water container into a disposable cylindrical mixing container, a disposable cylindrical alginate mixing container comprising a means of receiving said dispensed water, a plunger for dispensing the mixed compound from the container by means of linearly actuating the plunger from its initial position near the top of the container to a position near the bottom of the container, making a slidable interface to the sides of the cylindrical mixing container, thereby pushing the material from the container through an opening in the container provided for this purpose, a nozzle through which the compound is dispensed after exiting the container, and an amount of alginate compound powder contained therein.

The plunger is comprised of a plunger element, which seals against the sides of the container, but allows slidable movement of the plunger vertically within the container, an agitator assembly comprised of flexible cords anchored to an agitator body, which is rotatably engaged with plunger element, but has a means of providing a seal to the plunger element. The flexible cord is located towards the exterior wall of the container cylinder, and is terminated at each end in the agitator body, with additional cords located along the arm of the agitator. The cord is oriented at an oblique angle to the plane of the plunger, and is parallel to a plane through the vertical center axis of the container. The angle in the cord relative to the plunger plane provides a function of pre-stressing the cord against the reactive forces of impingement with the alginate compound during the mixing process, as the agitator is rotated in the direction of the cord emerging from the agitator during the mixing operation. This angular relationship of the cord to the plane of the agitator arms also allows stowage of the cord as the plunger is actuated towards the bottom of the container during the dispensing of the alginate compound from the container, by pre-collapsing the cord and assuring that the cord does not become a structural column impeding the progression of the plunger towards the bottom of the mixing container. A flap seal on the interior surface of the plunger, relative to the mixing container, allows the receipt of water, but provides a seal during mixing and dispensing of the alginate. A mixing shaft receiver to receive a mixing shaft to rotate the mixing element and perform the mixing of the water and the alginate compound powder is also incorporated.

A mixing shaft is received from the mixing driver to the mixing element to motivate the mixing element inside the alginate container and perform the mixing action of the contained alginate powder and the received water. This shaft is coupled to a variable speed motor and control.

The alginate is dispensed by the actuation of a screw by a geared motor under electric controls to linearly displace the cylinder relative to the piston, thereby compressing the alginate compound within and flowing it out the nozzle to an impression tray held in the dispensing area.

### BRIEF DESCRIPTION OF THE DRAWINGS

FIG. 1 is a diagram overview of the apparatus

FIG. 2 is a detail of the mixing container assembly

FIG. 3 is a detail of the mixing container assembly with the plunger in the final dispensing position

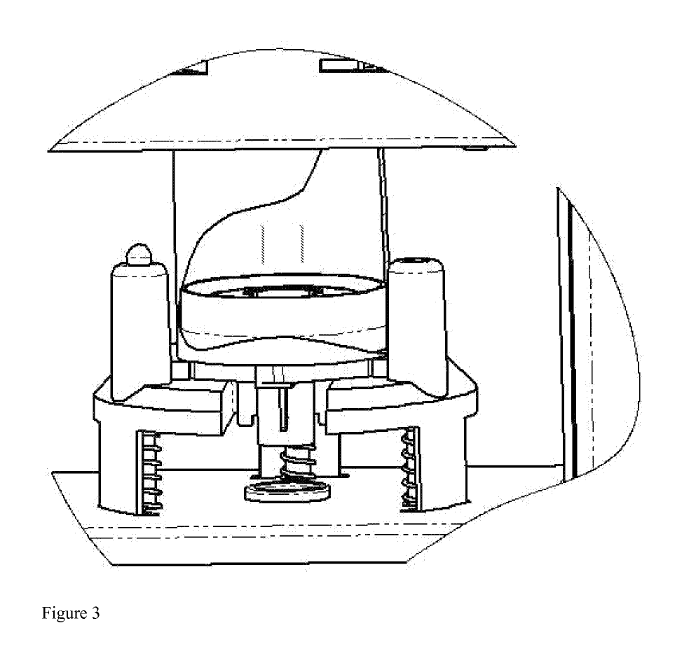

Other advantages and features will be apparent from the following description, and from the claims.

### DETAILED DESCRIPTION OF THE INVENTION

The systems and methods discussed herein are merely illustrative of specific manners in which to make and use this invention and are not to be interpreted as limiting scope.

While the systems and methods have been described with a certain degree of particularity, it is noted that many modifications may be made in the details of the construction and the arrangement of the devices, components and/or steps without departing from the spirit and scope of this disclosure. it is understood that the systems and methods are not limited to the embodiments set forth herein for the purposes of exemplification.

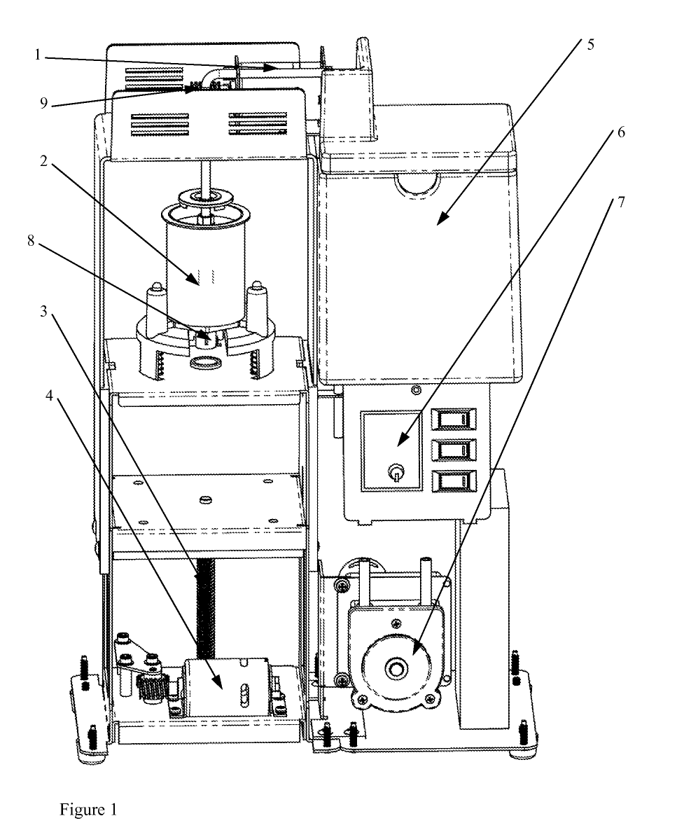

The system is shown in FIG. 1 and is comprised of a water tank 5, into which sterile water to be used in mixing alginate compound in the system is stored. The water tank supplies the alginate mixing container 2 by plumbing and a precision pump 7, such as a peristaltic pump, which is controlled to dispense an amount of water determined by the amount of alginate present in the mixing container.

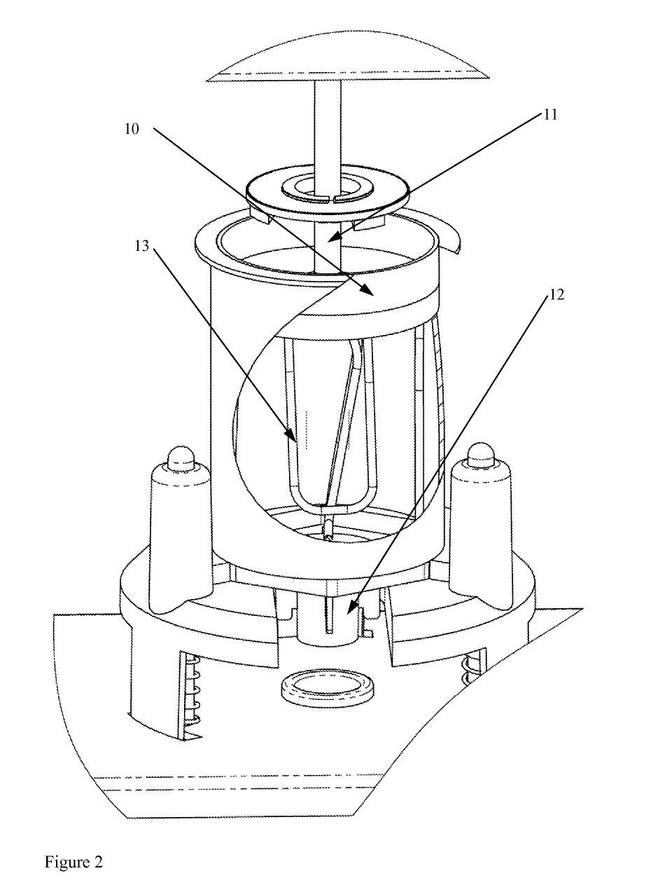

Additionally, a mixing drive shaft is fastened to a mixing drive motor 1, and is linearly received into the agitator body incorporated into a plunger assembly 10. The mixing motor rotates the drive shaft 11, which transmits the rotary motion to the agitator to perform the mixing operation. The agitator is comprised of an agitator body and mixing cords 13 as shown in FIG. 2, which provide the mechanical impingement required to mix the alginate and water. The plunger assembly contains a water inlet, which allows water dispensed from the pump to be received by the alginate container.

The mixing cords are engaged in the agitator body, and are oriented at a non-parallel and non-normal angle to the plane of the agitator arms, and are oriented roughly parallel to a plane passing through the vertical rotational axis of the mixing shaft at a distance from the mixing shaft axis. The angular relationship between the mixing cord and the agitator body arm plane provides two distinct functions. First, when the agitator is rotated in the direction of the cord emanating from the agitator body, the cord is flexed downwards by the force of impingement against the alginate and water. This maintains the cord in an approximate vertical orientation, normal to the plane of the agitator arms, and provides more efficient mixing and agitation then if the cords were initially oriented normal to the plane of the agitator arms, by pre-stressing the cord and providing a greater reactive force in the alginate compound being mixed. The mixing cord does not shear across the material, but engages it more directly, due to this angular orientation.

When the agitator is stopped, the cords retract back to the original angular orientation relative to the plane of the agitator arms as the pre-load in the cord relieves itself with the dissipation of the reactive mixing forces in the alginate compound. This provides a pre-buckling or pre-folded state of the cords, so that when the plunger assembly is actuated towards the bottom of the mixing container, the cords will collapse and fold until they are flat against the bottom of the mixing container. If the angular relationship is not established, the cords can become a structural column between the plunger face and the mixing container bottom, and can increase the force required to dispense alginate, or can make the dispensing function uneven and difficult to control. It is more likely that the alginate cannot be fully extracted from the mixing container, because the cords are tangled and preventing the plunger from being fully depressed.

Also, a motor 4 and screw assembly 5 are provided to actuate the plunger linearly and slidably within the mixing cylinder, thereby dispensing the mixed alginate compound into an impression tray placed below the dispensing nozzle 8 of the mixing cylinder. Electric controls 6 are provided to control the dispensed volume of water from the tank by controlling the number of turns of the pump. These controls also control the speed of the mixing motor and shaft, and the speed and position of the plunger within the alginate mixing container.

A mechanical structure or frame provides support for the various elements of the system and establishes their positional relationship to one another to provide the utility generated by the system.

The system herein described provides a more thorough mixing agitation of the alginate compound and water than a fixed blade or paddle system, and the cords are able to agitate the alginate mixture out of the corners of the mixing container. The system provides a uniform and consistent alginate product, and is not dependent upon the skill of the operator to achieve this consistency. This frees a skilled person to be utilized for other procedures in the dental office. The system is more cost effective and provides less risk of compromised sterility, due to improper cleaning or mixing of the compounds and the mixing equipment. The methods described herein can be accomplished in a cost-effective manner.

Whereas, the systems and methods have been described in relation to the drawings and claims, it should be understood that other and further modifications, apart from those shown or described herein, may be made within the spirit and scope of this invention.

What is claimed is:

1. A mixing container assembly incorporated by an alginate mixing machine, said container assembly comprising:
a cylindrical mixing container body,
a plunger assembly slidably engaged to the interior wall of said mixing container body, and providing a seal therewith, said plunger assembly comprising:
a plunger element,
and an agitator assembly rotably and sealably engaged by said plunger element, said agitator assembly comprising an agitator body with fixedly attached agitator elements, said elements being flexible cords attached to said agitator body at an oblique angle to a plane that is perpendicular to the axis of rotation of said agitator assembly in said plunger assembly, and incorporating an opening through the center of said agitator body, through which liquid may be fed into said mixing container assembly by a pipe or tube.

2. The alginate mixing machine of claim 1, where said alginate mixing machine incorporates an agitator drive assembly comprising:
a mixing container receiver, which receives the mixing container of claim 1 and retains it for the mixing process performed by said alginate mixing machine,
and a drive member assembly, comprising:
a hollow rotating drive shaft, through which a liquid dispensing pipe or tube may be fed,
and a drive member, said drive member fixibly attached to said drive shaft, and slidably engaging the agitator assembly of claim 1 when said mixing container is received by said mixing container receiver, and a positively rotably engaging said agitator assembly to cause rotation of said agitator assembly when said drive shaft of said alginate mixing machine is rotated.

3. The alginate mixing machine of claim 1, said alginate mixing machine incorporating a metered liquid dispensing system comprising:
a liquid tank,
a metering pump receiving liquid from said liquid tank, and dispensing it to a pump outlet,
a metering pump control and operator interface,
and a tube to dispense liquid from said metering pump outlet into the mixing container assembly of claim 1 from said metering pump outlet, by passing through the center of the agitator assembly of claim 1.

4. A dispensing assembly comprising:
a receiver body to receive the mixing container assembly of claim 1,
a plunger actuator assembly comprising:
a plunger slidably engaged to said receiver body
and the mixing container of claim 1.

5. The method of mixing dental alginate compounds utilizing the alginate mixing machine of claim 1.

6. The mixing container of claim 1, wherein the mixing container is pre-filled with alginate compound powder in a sealed package.
